(19) United States
(12) Patent Application Publication
(10) Pub. No.: US 2008/0259101 A1
(43) Pub. Date: Oct. 23, 2008

(54) METHODS AND APPARATUS FOR MINIMIZING THE NUMBER OF PRINT PASSES IN FLAT PANEL DISPLAY MANUFACTURING

(75) Inventors: Shinichi Kurita, San Jose, CA (US); John M. White, Hayward, CA (US)

Correspondence Address: DUGAN & DUGAN, PC, 245 Saw Mill River Road, Suite 309, Hawthorne, NY, 10532, US

(73) Assignee: APPLIED MATERIALS, INC.

(21) Appl. No.: 12/054,381

(22) Filed: Mar. 24, 2008

Related U.S. Application Data
(60) Provisional application No. 60/896,893, filed on Mar. 23, 2007.

(51) Int. Cl. B41J 2/01

(52) U.S. Cl. 347/1

(57) ABSTRACT

A system for inkjet printing includes a first set including a first inkjet print head having a first plurality of nozzles adapted to selectively dispense a first ink, and a second inkjet print head having a second plurality of nozzles adapted to selectively dispense a second ink; a second set including a third inkjet print head having a third plurality of nozzles adapted to selectively dispense a third ink and a fourth inkjet print head having a fourth plurality of nozzles adapted to selectively dispense a fourth ink; and a stage adapted to support the substrate and transport the substrate below the first and second sets during a printing pass; wherein the first set is adapted to dispense the first and second inks into respective adjacent color wells of a display pixel on a substrate and the second set is adapted to dispense the third and fourth inks into respective adjacent color wells of a display pixel on a substrate.

### CROSS-REFERENCE TO RELATED APPLICATIONS

This patent application claims priority to U.S. Provisional Patent Application Ser. No. 60/896,893, filed Mar. 23, 2007 and titled “METHODS AND APPARATUS FOR MINIMIZING THE REQUIRED NUMBER OF PRINT PASSES” (Attorney Docket No. 11516/L/DISPLAY/AKT/RKK), which is hereby incorporated herein by reference in its entirety.

This patent application is related to U.S. Provisional Patent Application Ser. No. 60/785,594, filed Mar. 24, 2006 and titled “METHODS AND APPARATUS FOR INKJET PRINTING” (Attorney Docket No. 9521/L04/DISPLAY/AKT/RKK), which is hereby incorporated herein by reference in its entirety.

Further, the present application is related to the following commonly-assigned, co-pending U.S. patent applications, each of which is hereby incorporated herein by reference in its entirety for all purposes:

U.S. Provisional Patent Application Ser. No. 60/625,550, filed Nov. 4, 2004 and entitled “APPARATUS AND METHODS FOR FORMING COLOR FILTERS IN A FLAT PANEL DISPLAY BY USING INKJETTING” (Attorney Docket No. 9521/L);

U.S. patent application Ser. No. 11/019,967, filed Dec. 22, 2004 and titled “APPARATUS AND METHODS FOR AN INKJET HEAD SUPPORT HAVING AN INKJET HEAD CAPABLE OF INDEPENDENT LATERAL MOVEMENT” (Attorney Docket No. 9521-1);

U.S. patent application Ser. No. 11/019,930, filed Dec. 22, 2004 and titled “METHODS AND APPARATUS FOR ALIGNING PRINT HEADS” (Attorney Docket No. 9521-3);

U.S. patent application Ser. No. 10/781,953, filed Feb. 19, 2004 and titled “METHODS AND APPARATUS FOR POSITIONING A SUBSTRATE RELATIVE TO A SUPPORT STAGE” (Attorney Docket No. 8166);

U.S. Provisional Patent Application 60/703,146, filed Jul. 28, 2005 and titled “METHODS AND APPARATUS FOR SIMULTANEOUS INKJET PRINTING AND DEFECT INSPECTION” (Attorney Docket No. 9521-L02 (formerly 9521-7));

U.S. patent application Ser. No. 11/212,043 filed Aug. 25, 2005 and entitled “METHODS AND APPARATUS FOR ALIGNING INKJET PRINT HEAD SUPPORTS” (Attorney Docket No. 9521-6); and

U.S. patent application Ser. No. 11/466,507 filed Aug. 23, 2006 and entitled “METHODS AND APPARATUS FOR INKJET PRINTING COLOR FILTERS FOR DISPLAYS USING PATTERN DATA” (Attorney Docket No. 9521-P04).

### FIELD OF THE INVENTION

The present invention relates generally to flat panel display manufacturing, and more particularly to methods and apparatus for inkjet printing.

### BACKGROUND

The flat panel display industry has been attempting to employ inkjet printing to manufacture display devices, in particular, color filters. One problem with effective employment of inkjet printing is that it is difficult to inkjet ink or other material accurately and precisely on a substrate while having high throughput. Accordingly, there is a need for improved methods and apparatus for efficiently positioning inkjet heads above drop locations on a substrate (e.g., so as to reduce the number of printing passes required for depositing ink on the substrate).

### SUMMARY OF THE INVENTION

A system for inkjet printing includes a first set including a first inkjet print head having a first plurality of nozzles adapted to selectively dispense a first ink, and a second inkjet print head having a second plurality of nozzles adapted to selectively dispense a second ink; a second set including a third inkjet print head having a third plurality of nozzles adapted to selectively dispense a third ink and a fourth inkjet print head having a fourth plurality of nozzles adapted to selectively dispense a fourth ink; and a stage adapted to support the substrate and transport the substrate below the first and second sets during a printing pass; wherein the first set is adapted to dispense the first and second inks into respective adjacent color wells of a display pixel on a substrate and the second set is adapted to dispense the third and fourth inks into respective adjacent color wells of a display pixel on a substrate.

Other features and aspects of the present invention will become more fully apparent from the following detailed description, the appended claims, and the accompanying drawings.

### BRIEF DESCRIPTION OF THE DRAWINGS

FIG. 1 is a block diagram depicting an example of an embodiment of a flat panel manufacturing system according to the present invention.

FIG. 2 is a schematic representation depicting an example of an inkjet printing system according to the present invention.

FIG. 3 is a schematic representation depicting close-up view of the inkjet printing system of FIG. 2.

FIG. 4 is a flow chart depicting an example method according to embodiments of the present invention.

FIGS. 5A through 5J are a representation of an example sequence of print passes executed by the inkjet printing system of the present invention.

### DETAILED DESCRIPTION

The present invention provides methods and apparatus for improving printing efficiency by reducing the number of times a substrate is required to pass under an inkjet printer head, particularly when printing using multiple print heads adapted to print on a wide variety of differently sized substrates. According to the present invention, multiple sets of print heads may be arranged to dispense ink onto a substrate as the substrate is transported below the sets. Each set may include more than one print head disposed such that the set is operable to dispense a different ink into adjacent or non-adjacent sub-pixel wells of display pixels on the substrate. This may be achieved by using a different print head for each color ink and offsetting the print heads within a set relative to each other in a direction perpendicular to the print direction by an offset amount (e.g., an offset distance). Additionally or alternatively, the above functionality may be achieved by rotating the sets of print heads about a central axis such that a center-to-center distance in a direction perpendicular to the print direction between corresponding nozzles of adjacent print heads is approximately equal to a center-to-center distance of adjacent color wells of the display pixels. For example, and as described further below, using three sets of print heads, each set including three print heads (e.g., nine print heads in total), three different inks may be deposited into each display pixel of a display object in one third the number of printing passes required by conventional systems. In some embodiments, each set may be used to print a different display object (or column of display objects).

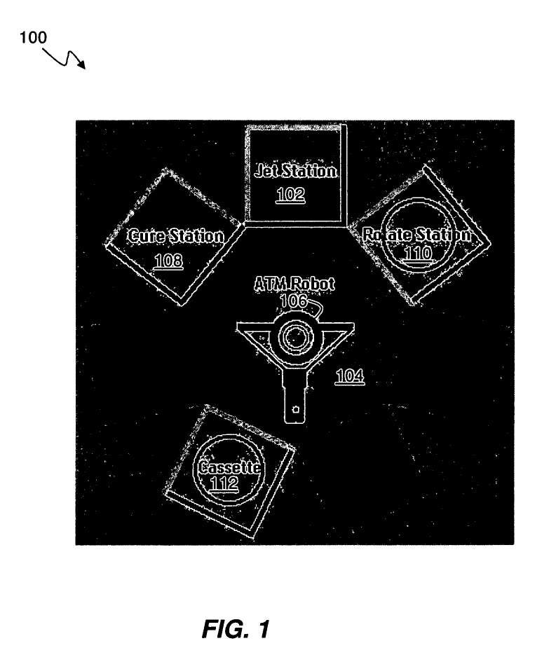

Turning to FIG. 1, an example embodiment of a flat panel display manufacturing system 100 according to the present invention is illustrated. The system 100 may include an inkjet printing system 102 (labeled as “jet station”) that is loaded with substrates via a transfer chamber 104 by a robot 106. The system 100 may also include a cure station 108, a rotation station 110, and a cassette storage location 112.

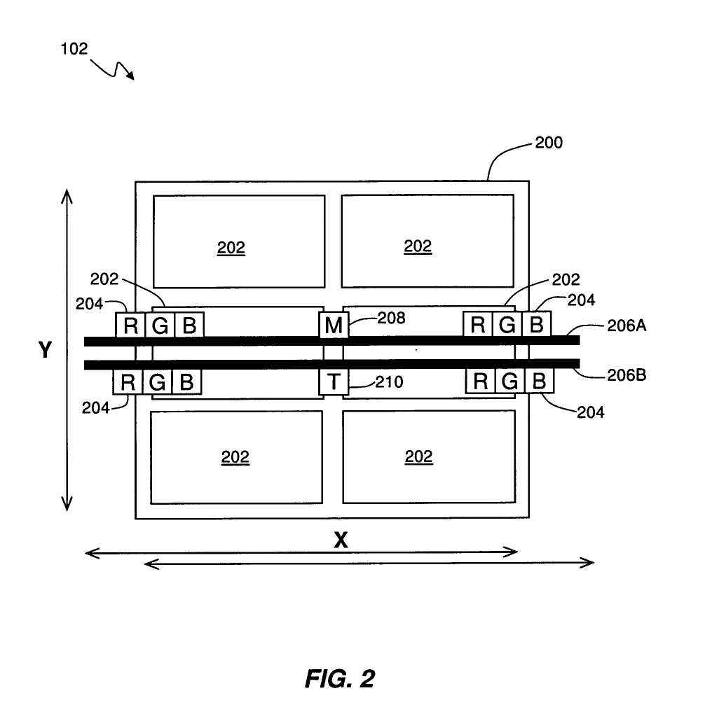

Turning to FIG. 2, a schematic representation of the inkjet printing system 102 is depicted. The printing system 102 includes a stage 200 for supporting a substrate which may include a plurality of display objects 202 to be printed. The substrate is moved below groups of print heads 204 that are supported by print bridges 206A, 206B. In some embodiments, more or fewer sets of print heads and/or print bridges may be employed. The substrate is moved in the Y direction and the print heads move in the X direction. The system may also include a microscope 208 and a thickness measurement system 210 for examining the substrate before, during, and/or after printing.

When employing multiple sets of print heads in a printing operation (e.g., twelve print heads), it is useful to determine how to execute the jetting of ink onto the display object(s) of the substrate(s) with complete coverage in the fewest number of print passes possible in order to maximize throughput. This determination depends, among other possible factors, upon the size and configuration of display object(s) and the size and configuration of the substrate(s). In one or more embodiments, such a determination may involve calculation of: a system throughput time, a minimum number of printing passes required based on the number of print heads employed (based in part on the display object and substrate configuration), and initial print head printing positions. A number of other parameters and factors such as parking time, the size of the print heads, etc. may be employed in such calculations. It is noted, however, that other throughput optimization techniques may be used based on the same or other factors. The determination may be performed by one or more controllers (not shown) coupled to each of the sets 801, 802, 803, 804. An embodiment of a controller that may be used in the context of the present invention is described in previously incorporated U.S. patent application Ser. No. 11/466,507.

A printing algorithm has been developed for a multi-inkjet head inkjet system. In particular, a twelve head system may be used, but the present invention may be applied to other numbers of heads. Twelve heads may be arranged in two rows (e.g., on two print bridges that span the system in the X direction, wherein the Y direction is the printing direction) to increase the system throughput. In a twelve head system, since the system may print using three colors, there may be four sets of color groups in the system. Other numbers of colors (e.g., 4, 5, 6, etc.) are possible. Such grouping also makes it possible to run the system continuously even when some heads fail or become inoperative. The present invention thus increases the system throughput via minimizing the required number of print passes and supports the use of redundant sets of inkjet head printing groups in case individual heads fail.

In some printing system designs, there are six heads 204 on both sides of the system 102, and there may be microscope cameras 208 and a thickness measurement system (TMS) 210 disposed in the center of the X motion stroke. The microscope cameras 208 and the TMS 210 are useful for measuring and verifying the printing quality after printing. These devices may be installed in the center of the X beam 206A, 206B (gantry or print bridge) to access all substrate areas without extending the X motion stroke. Before the start of printing, all heads 204 may be in a parking position, bathed in solvent to prevent clogging of the inkjet nozzles. To print a single substrate, the inkjet heads are moved to a wiping station (not shown) to clean the nozzles on the heads. After cleaning the heads, the heads are moved to the first pixels on the substrate based on a calculation described below and the substrate is printed according a calculated number of passes or swaths.

The system throughput for the jetting process may be expressed as:

Tm_wipe+Twipe+Tm_print+Tprint*number_of_swath

where Tm_wipe is time required to move to the wiping station, Twipe is the wiping time, Tm_print is the time to move to the first jetting position, and Tprint is the printing time for one swath. To compute the number of printing swaths, the following equation may be used:

(Nline+2*Nhead_gap)/4+1

where Nline is the total number of printing lines, and Nline is calculated based on:

number_of_jet_display*number_of_display_x+number_of_jet_gap

where number_of_jet_display is calculated based on:

number_of_nozzle_per_pixel*number_of_pixel_on_x/number_of_nozzle

where number_of_display_x is the count of the display in the X direction, and number_of_jet_gap is:

head_pitch_x/width_of_head

where width_of_head is calculated based on:

number_of_nozzle/number_of_nozzle_per_pixel*pixel_width

After the number of swaths, which is the minimized number of printing passes with, in this case, twelve heads, is calculated, the jet heads are set to the first printing position to start the print process. The first printing positions are calculated by:

X1[0]=Ppark

X2[0]=Pwipe

X3[0]=Pf_pixel

X4[0]=X3[0]+Whead_width×Ngap

if(X4[0]+Whead_width×Ngap)>(Lx−Nswath×Whead_width)

X5[0]=X4[0]+Whead_width×Ngap

else

X5[0]=Lx−Npark×Whead_width

X6[0]=Pwipe

X7[0]=Ppark

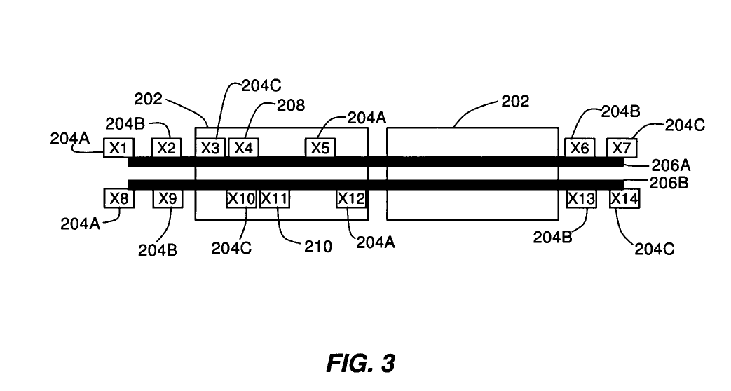

X8[0] . . . X14[0]=X1[0] . . . X7[0]+Whead_width

where, Ppark is the position of parking, Pwipe is the position of wiping, Pf_pixel is the position of the first pixel, Ngap is the number of gaps between heads, Lx is the length x of the substrate, Nswath is the number of the swath, and Whead_width is the width of the head for printing. Once the first position is assigned to the heads, the head can move to next position adding the width of the printing head times the number of swaths. FIG. 3 depicts the above listed positions of the heads 204A, 204B, 204C for each of the four sets as well as the microscope 208 and the TMS 210. The Y position information may be calculated as follows:

Y_start_motion_pos[0]=Y_start_jet_pos[0]−Ad−Hg

Y_start_jet_pos[0]=Pf

Y_stop_jet_pos[0]=Pf+Ly

Y_stop_motion_pos[0]=Y_stop_jet_pos[0]+Ad+Hg

Where Ad is the Acceleration distance which is equal to ½ vt wherein v is velocity and t is acceleration time. Hg is Head gap in the vertical direction (e.g., approximately 400 mm), Pf is the position of the first pixel, and Ly is the length y of the substrate. For example Ad is 125 mm when the velocity is 0.5 m/sec and the acceleration is 1.0 and 20 mm when the velocity is 0.2 m/sec and the acceleration is 1.0.

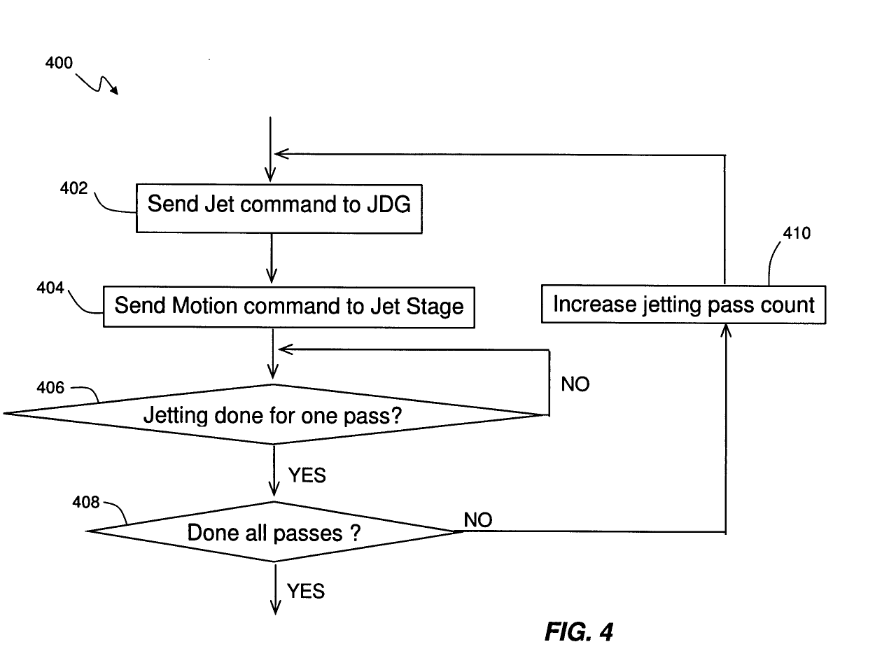

Turning to FIG. 4, an example process 400 for printing is depicted. This process 400 may commence once the heads 204 are in the above listed positions. In Step 402, the jet command is sent to the jet data generator from the printing system's controller. In Step 404, the motion command is sent to the stage of the print system 102. In Step 406, the controller determines if a pass is complete. If it is, in Step 408, the controller determines if all passes are complete. If all passes are complete, the process ends. Otherwise, flow loops back to Step 410 where the print pass count is incremented and flow returns to Step 402 for the next print pass.

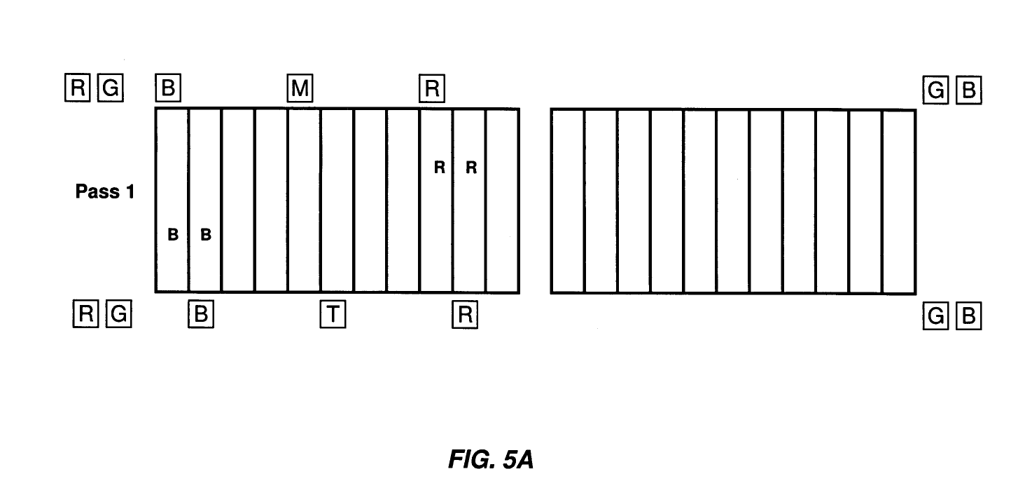

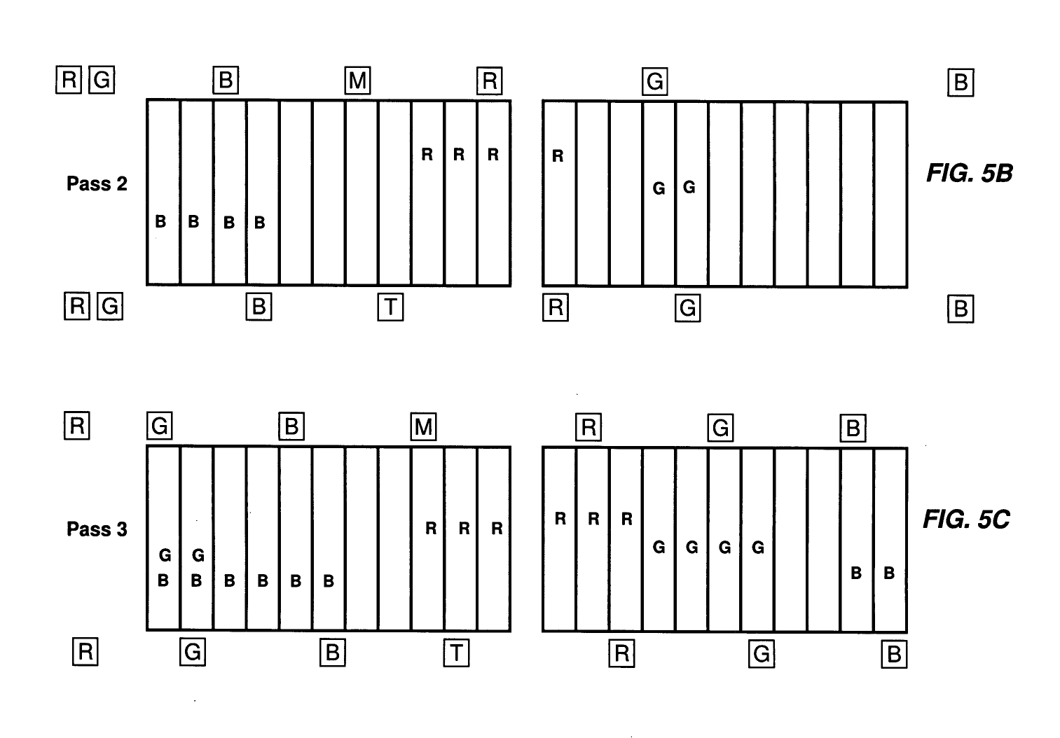

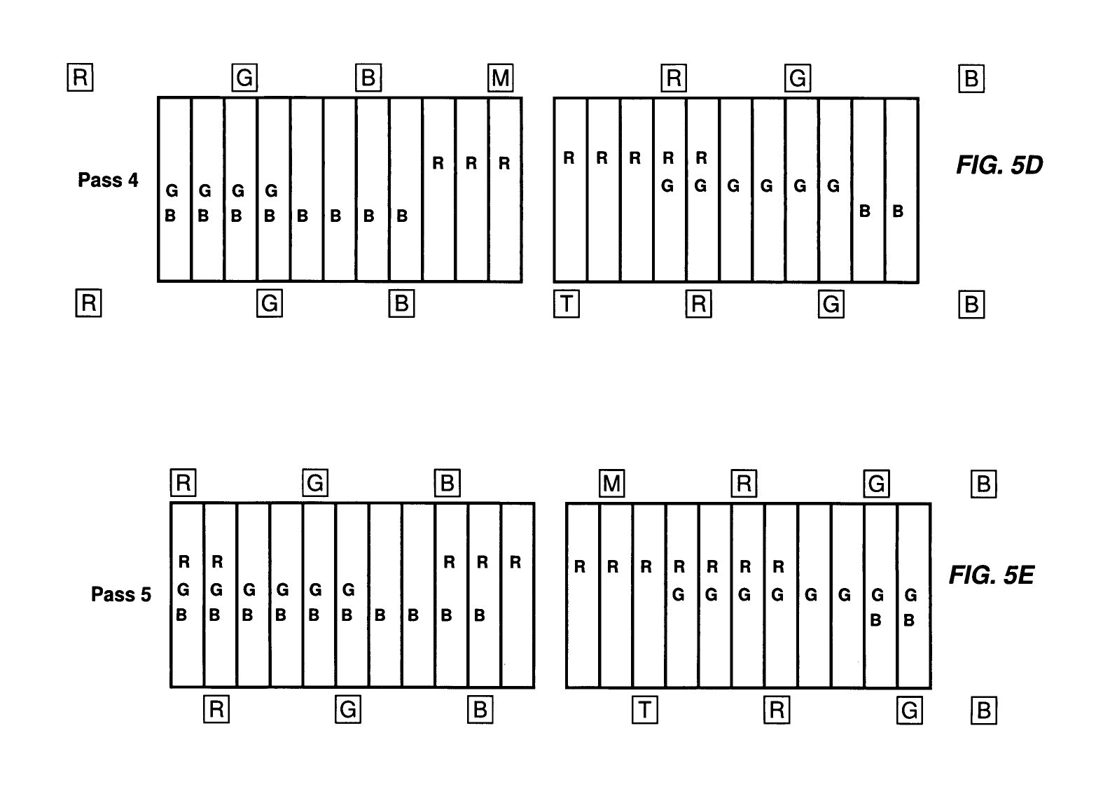

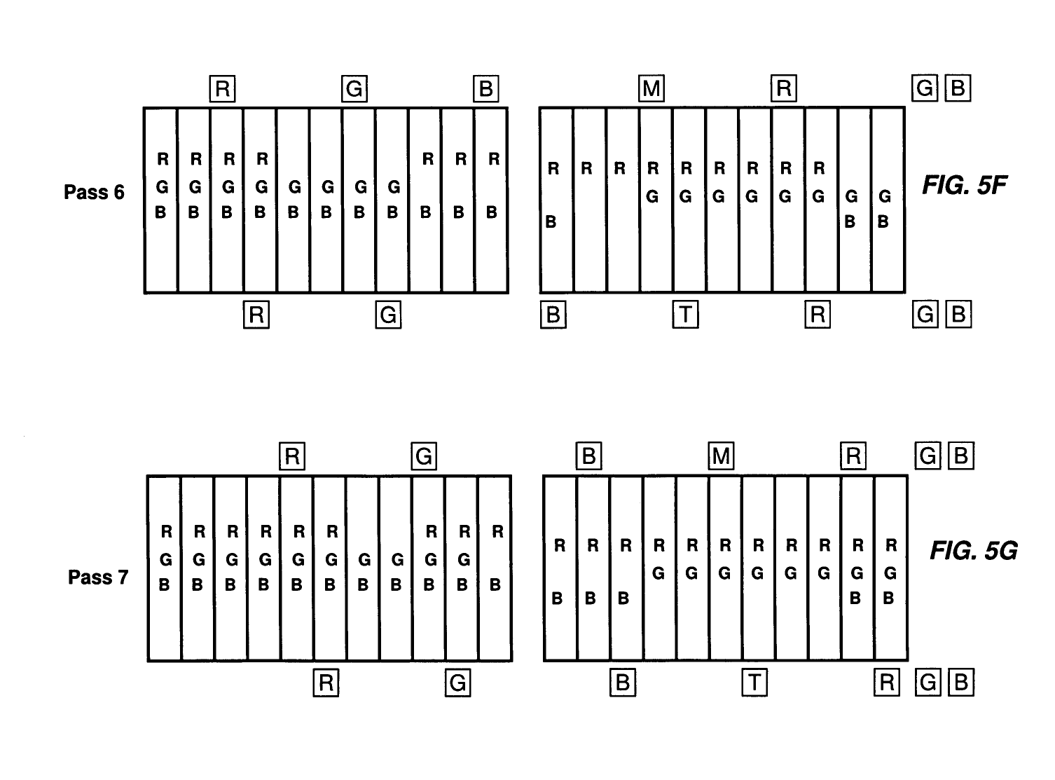

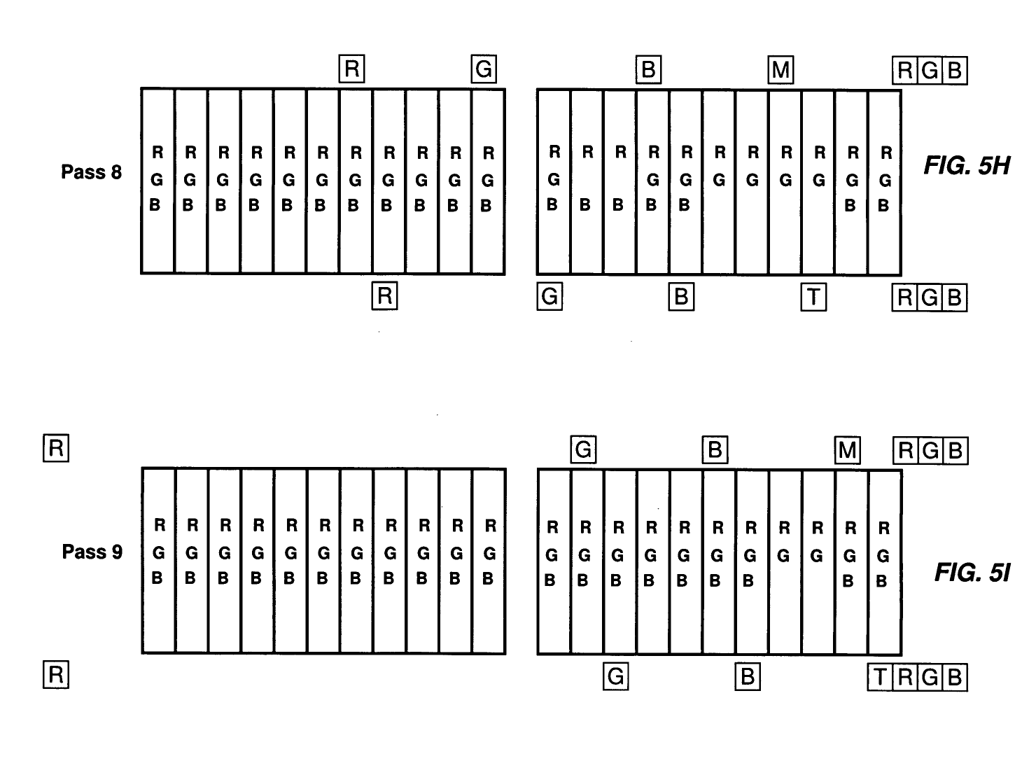

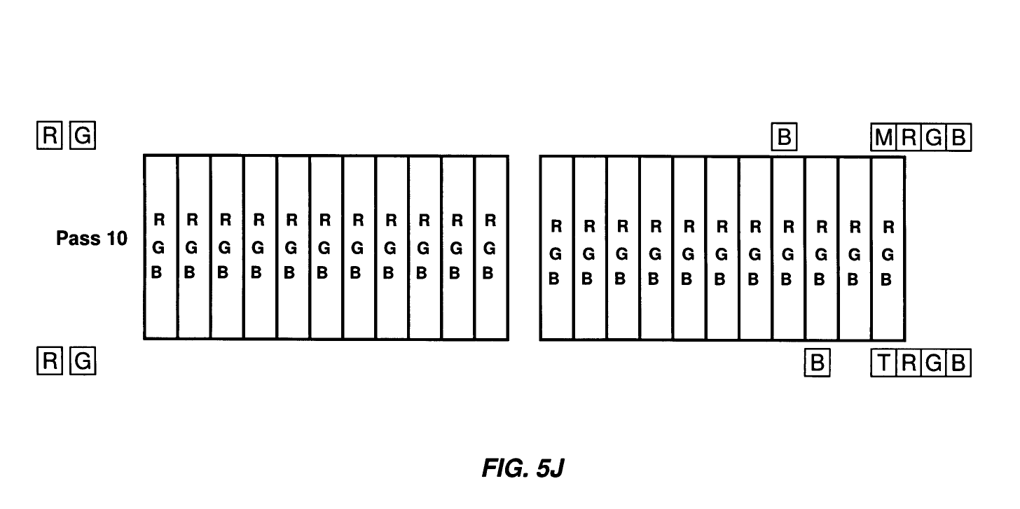

FIGS. 5A through 5J depict a sequence of 10 print passes. Each column represents the width of a single print head and the red prints head R, the green print heads G, and the B print heads B, are represented by lettered boxes. As each head executes a print pass, the columns are labeled with the ink's color. The sequence illustrates the algorithm for printing eight 27″ display objects (1366×768) although only two display objects are represented.

The equation described above may be extended to support jetting with less than twelve heads, e.g., if some of the heads are inoperative. For example, if one head is inoperative, one group of heads (R, G, and B) may be deactivated for repair, and the previous equation may be applied in such a case. With the equation:

(Nline+2*Nhead_gap)/Ngroup+((Ngroup+1)%2)

the system can continue to operate with as few as three operable heads. In the above equation, ‘Ngroup’ is the number of the print head group.

Some comparative illustrative example performance results of the present invention printing on a “60K” substrate size (e.g., 2600 mm×2230 mm) include:

Using twelve inkjet heads,
Layout: 52″ and 57″ (1920×1080)×6 display objects
Pixel size: 200×600 (52″), 220×600 (57″)
Number of swaths: 19
Motion velocity: x: 500 mm/sec., y: 500 mm/sec
Process time: 116.49 sec. (52″) and 120.2 sec. (57″)
Throughput (substrate/hr.) including glass exchange time: 23.93 (52″), 23.35 (57″)
   Using 9 Inkjet heads,
Number of swaths: 24
Process time: 144.82 sec. (52″) and 149.58 sec. (57″)
Throughput (substrate/hr.) including glass exchange time: 20.1 (52″), 19.6 (57″)
   Using 6 Inkjet heads,
Number of swaths: 36
Process time: 213.0 sec. (52″) and 220.1 sec. (57″)
Throughput (substrate/hr.) including glass exchange time: 14.6 (52″), 14.2 (57″)
   Using 3 Inkjet heads,
Number of swaths: 70
Process time: 406.19 sec. (52″) and 419.9 sec. (57″)
Throughput (substrate/hr.) including glass exchange time: 8.2 (52″), 7.9 (57″)

Using the above describe invention, the number of swaths may be calculated based on the layout and substrate size. The invention may be used for 60K sized substrates but applies to all glass sizes including Gen 9 and beyond. The following example values were calculated using twelve inkjet heads for printing:

60K substrate size (2600 mm×2230 mm)
19 swaths for 52″ and 57″ (1920×1080)×6 display
   20K substrate size (1300 mm×1500 mm)
9 swaths for 27″ (1366×768)×8 displays
15 swaths for 32″ (1366×768)×6 displays
8 swaths for 37″ (1920×1080)×3 displays
11 swaths for 56″ (3840×2160)×2 displays

Thus, the system throughput is increased by decreasing the number of printing swaths, and the developed method generates the minimum number of printing passes on different sizes of substrates and different display object layouts.

The foregoing description discloses only particular embodiments of the invention; modifications of the above disclosed methods and apparatus which fall within the scope of the invention will be readily apparent to those of ordinary skill in the art. For example, while the steps of the methods described above are presented in a particular order, many alternative orders are possible and many additional sub-steps, super-steps, and/or alternative steps may be used.

Accordingly, while the present invention has been disclosed in connection with specific embodiments thereof, it should be understood that other embodiments may fall within the spirit and scope of the invention, as defined by the following claims.

The invention claimed is:

1. A system for inkjet printing, comprising:
a first set including a first inkjet print head having a first plurality of nozzles adapted to selectively dispense a first ink, and a second inkjet print head having a second plurality of nozzles adapted to selectively dispense a second ink;
a second set including a third inkjet print head having a third plurality of nozzles adapted to selectively dispense a third ink and a fourth inkjet print head having a fourth plurality of nozzles adapted to selectively dispense a fourth ink; and
a stage adapted to support the substrate and transport the substrate below the first and second sets during a printing pass;
wherein the first set is adapted to dispense the first and second inks into respective adjacent color wells of a display pixel on a substrate and the second set is adapted to dispense the third and fourth inks into respective adjacent color wells of a display pixel on a substrate.
